(19) United States
(12) Patent Application Publication
(10) Pub. No.: US 2011/0048573 A1
(43) Pub. Date: Mar. 3, 2011

(54) APPARATUS AND METHOD FOR PROVIDING A STERILE LIQUID FOR A FILLING SYSTEM

(75) Inventor: Oliver Martini, Regensburg (DE)

(73) Assignee: KRONES AG, Neutraubling (DE)

(21) Appl. No.: 12/868,799

(22) Filed: Aug. 26, 2010

(30) Foreign Application Priority Data
Aug. 28, 2009 (DE) 102009039180.0

(51) Int. Cl. B67C 3/22

(52) U.S. Cl. 141/1; 141/85

(57) ABSTRACT

An apparatus for providing a sterile liquid for a filling system for filling containers, including a first liquid reservoir for receiving a first liquid, a second liquid reservoir for receiving a second liquid, a sterilizing device for sterilizing the first and/or second liquid, and a withdrawal device for selectively withdrawing a sterile liquid from the first or second liquid reservoir.

### CROSS-REFERENCE TO RELATED APPLICATION

The present application claims the benefit of priority of German Application No. 102009039180.0, filed Aug. 28, 2009. The entire text of the priority application is incorporated herein by reference in its entirety.

### FIELD OF THE DISCLOSURE

The present disclosure relates to an apparatus and a method for providing a sterile liquid for a filling system, particularly for a bottling system.

### BACKGROUND

Filling systems often require sterile liquids, for instance sterile water, for very different purposes, for instance for the hygienization of the filler or also of the containers or bottles. Sterile water is e.g. also used for screw-thread spraying, or the like.

Sterile water is particularly also used for the internal and external disinfection or sterilization of the filling system. A method for cleaning and sterilizing inner surfaces of the pipe system of a filling system is e.g. known from JP 2007-022600.

In the prior art, a liquid tank that is filled with water is normally provided. The water is sterilized by performing an ultra-high temperature treatment. The sterile water can subsequently be passed into the system in case of need. Alternatively, a chemical sterilization of the water by means of a disinfectant may also be carried out. Methods for preparing a disinfectant are e.g. known from DE 10 2006 007 931, DE 20 2005 008 695 or EP 0 470 841 (see also GB 2 057 501 with respect to the electrochemical activation).

After consumption of the sterile water the liquid tank must be filled again in this case and the newly filled-in water must be sterilized. This may cause time delays in the process sequence or downtimes of the filler. To keep these delays as short as possible, use is made of a high concentration of disinfectants so as to achieve the necessary degree of sterility in a relatively fast way. Due to the aggressiveness of the disinfectants their high concentration in the sterile water may however in the long run damage pipes, valves, or the like, that are contained in the system and get into contact with the sterile water.

### SUMMARY OF THE DISCLOSURE

It is therefore an aspect of the present disclosure to provide a method and an apparatus which makes it possible to provide a sterile liquid for a filling system in a more efficient way.

The apparatus according to the disclosure comprises a first liquid reservoir for receiving a first liquid, a second liquid reservoir for receiving a second liquid, a sterilizing device for sterilizing the first and/or second liquid, and a withdrawal device for the selective withdrawal of a sterile liquid from the first or second liquid reservoir.

Owing to the provision of two liquid reservoirs, from which a sterile liquid can be selectively taken, the apparatus according to the disclosure makes it possible to withdraw the sterile liquid from the second liquid reservoir, for instance after a liquid reservoir has been emptied. As a result, major interruptions in the process sequence can be avoided, the process sequence being thereby made more efficient. The sterile liquid may particularly be sterile water (sterilized water). The first and/or second liquid may be water or comprise water. The first or second liquid may be a sterile liquid. In this instance the first or second liquid need not be sterilized. For instance, the first or second liquid may conform to a cleaning liquid.

Owing to the sterilization of the first and/or second liquid a sterile liquid can be provided in the first and/or second liquid reservoir.

The filling system may serve to fill containers, particularly vessels, e.g. bottles of glass or plastics. The filling system may serve to fill containers with liquids, e.g. with beverages or medicinal products.

The withdrawal device can comprise two valves. The valves may be configured such that a sterile liquid can selectively be taken from the first or second liquid reservoir. The withdrawal device may be connected to the filling system, no that the sterile liquid is passed on into or to the filing system.

The first and second liquid reservoir may conform to a first or second liquid tank. The first and second liquid reservoirs may be liquid tanks that are completely separated from each other in space, or conform to two sub-areas of a liquid tank. In this instance the two sub-areas may be separated from each other by a partition wall.

The apparatus may be designed such that, while a sterile liquid is being withdrawn from one of the liquid reservoirs, the liquid is sterilized in the other liquid reservoir. As a result, it is particularly possible to use a lower concentration of disinfectant when a disinfectant is used for sterilizing the first and/or second liquid. Although a lower concentration of disinfectant shows a slower disinfecting action than a higher concentration, downtimes can nevertheless be reduced or avoided due to the fact that during sterilization in one liquid reservoir the sterile liquid from the other liquid reservoir is used.

Particularly, the sterilizing device can introduce a disinfectant into the first and/or second liquid for sterilization. The disinfectant may comprise chlorine or peracetic acid. The disinfectant may be a disinfectant prepared by means of electrochemical activation or may be a chemical disinfectant.

The sterilizing device may be designed such that the same disinfectant is introduced into the first liquid and into the second liquid. Alternatively, or in addition, the sterilizing device may be configured such that a first disinfectant is introduced into the first liquid and a second disinfectant is introduced into the second liquid, with the first disinfectant being different from the second disinfectant.

The disinfectant may have a first concentration in the first liquid and a second concentration in the second liquid. Particularly, the concentration of the disinfectant in the first liquid may be equal to or different from the concentration of the disinfectant in the second liquid.

The concentration of the disinfectant in the first and/or the second liquid can be chosen in conformity with the desired use of the sterile liquid in the filling system. Particularly, it is possible to choose a concentration for the disinfectant that in the long run does not damage materials of the filling system that get into contact with the sterile liquid. In other words, the concentration of the disinfectant in the sterile water can be chosen such that a corrosive action is minimized.

The withdrawal device may comprise a control element that is configured such that when the liquid level of the sterile liquid in the first or second liquid reservoir falls below a predetermined limit value, the withdrawal of the sterile liquid from the first or second liquid reservoir is stopped automatically.

Particularly, the control element may be designed such that, after the withdrawal of the sterile liquid from a liquid reservoir has been stopped, the sterile liquid is automatically withdrawn from the other liquid reservoir. Process interruptions can thereby be kept short.

Moreover, the present disclosure provides a system comprising a filling system for filling containers and one of the above-described apparatuses for providing a sterile liquid. The filling system can particularly be designed in the above-described way.

The system may comprise a connection element which is designed such that the sterile liquid is passed by the apparatus for providing a sterile liquid by means of the connection element into or to the filling system.

Moreover, the present disclosure provides a method for providing a sterile liquid for a filling system for filling containers, the method comprising the steps of:

providing a first and a second liquid reservoir;

providing a first liquid in the first liquid reservoir and a second liquid in the second liquid reservoir;

sterilizing the first and/or second liquid; and

withdrawing a sterile liquid selectively from the first or second liquid reservoir.

The sterile liquid, the first liquid, the second liquid, the filling system, the first liquid reservoir and/or the second liquid reservoir may comprise one or more of the above-described features. Particularly, the method for providing a sterile liquid for a filling system can be carried out with one of the above-described apparatuses for providing a sterile liquid.

Particularly, while a sterile liquid is withdrawn from one of the liquid reservoirs, the liquid can be sterilized in the other liquid reservoir.

The sterilizing operation may comprise introducing a disinfectant into the first and/or second liquid. The disinfectant may comprise one or more of the above-described features of a disinfectant. Particularly, the introduced disinfectant may have a first concentration in the first liquid and a second concentration in the second liquid.

For instance, a sterile liquid from the first liquid reservoir with a higher concentration of disinfectant can be used for sterilizing the filling system, and a sterile liquid from the second liquid reservoir with a lower concentration of disinfectant can be used for after-rinsing. Residues of the disinfectant in the filling system can thereby be minimized or avoided.

### BRIEF DESCRIPTION OF THE DRAWINGS

Further features and advantages shall now be explained with reference to the exemplary figures, in which:

FIG. 1 illustrates an apparatus for providing a sterile liquid for a filling system, wherein a sterile liquid is withdrawn from a first liquid reservoir;

FIG. 2 illustrates an apparatus for providing a sterile liquid, wherein a sterile liquid is withdrawn from a second liquid reservoir;

FIG. 3 illustrates an apparatus for providing a sterile liquid, wherein during withdrawal of a sterile liquid from a second liquid reservoir a liquid is sterilized in the first liquid reservoir;

FIG. 4 illustrates an apparatus for providing a sterile liquid, wherein a cleaning liquid is disposed in a first liquid reservoir;

FIG. 5 illustrates an apparatus for providing a sterile liquid, wherein a concentration of a disinfectant in a first liquid reservoir is lower than a concentration of the disinfectant in a second liquid reservoir;

FIG. 6 illustrates an apparatus for providing a sterile liquid, wherein the sterile liquid from a first liquid reservoir is used for rinsing the filling system.

### DETAILED DESCRIPTION OF THE PREFERRED EMBODIMENT

The sterile liquid shall be assumed to be sterile water (sterilized water) in the following. Other sterile liquids are however also possible.

The following examples describe a chemical sterile-water preparation by means of a disinfectant. The disinfectant may be a disinfectant produced by means of electrochemical activation or a conventional chemical disinfectant.

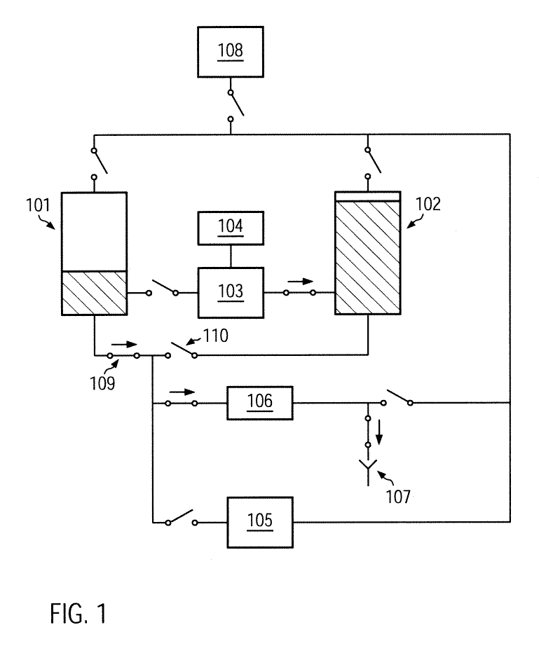

FIG. 1 illustrates a system composed of an apparatus for providing a sterile liquid and of a filling system. The apparatus for providing a sterile liquid particularly comprises a first liquid reservoir 101 and a second liquid reservoir 102. Moreover, the system comprises a sterilizing device, comprising an element 104 for producing a disinfectant and an element 103 for introducing the disinfectant into a first liquid in the first liquid reservoir 101 and/or into a second liquid in the second liquid reservoir 102.

Moreover, the system comprises a filling system for filling containers, comprising a filler 105 for effectively filling the containers and a sterile-water consumption element 106 which serves e.g. to clean the containers. Moreover, the filling system comprises an outlet 107 through which the consumed sterile water can be discharged.

Moreover, the system shown in FIG. 1 comprises a CIP (cleaning-in-place) system for cleaning the system.

In the example illustrated in FIG. 1 sterile water is supplied from the first liquid reservoir 101 with a predetermined concentration of disinfectant. The withdrawal device of the apparatus for providing a sterile liquid comprises two valves 109, 110. In this example the first valve 109 is opened, i.e. sterile water can be withdrawn from the first liquid reservoir 101 and passed to the sterile-water consumption element 106 of the filling system. During withdrawal of the sterile water from the first liquid reservoir 101, water is sterilized in the second liquid reservoir 102. For this purpose a disinfectant from element 103 is passed into the second liquid reservoir. Since during this period sterile water is taken from the first liquid reservoir 101, it is possible to work with a lower concentration of disinfectant. A low concentration of disinfectant normally prolongs the disinfection time. Therefore, in systems having only one liquid reservoir a higher concentration is used most of the time so as to keep process interruptions for preparing the sterile water as short as possible.

In the example shown in FIG. 1, the concentration of disinfectant has been chosen such that residues of the disinfectant, for instance in the containers washed with the sterile water, are minimized. Moreover, the concentration has been chosen such that materials of the filling system that get into contact with the sterile water do not get damaged in the long run. In other words, the concentration of the disinfectant in the sterile water has been chosen such that a corrosive action is minimized. Chlorine or peracetic acid may e.g. be used as disinfectant. In the case of chlorine a low concentration may be 25 mg/l to 75 mg/l, particularly 45 mg/l to 55 mg/l, particularly 50 mg/l of Cl⁻. In the case of peracetic acid, the concentration may be 100-300 ppm, particularly 180-220 ppm, particularly 200 ppm.

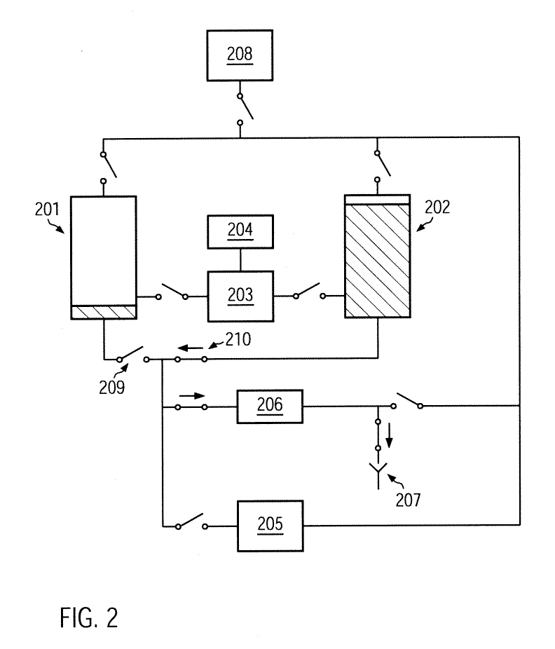

FIG. 2 illustrates the exemplary system of FIG. 1 at a later time, wherein the liquid level of the sterile water in the first liquid reservoir 201 has fallen below a predetermined limit value. Valve 209 has therefore been closed and valve 210 opened. Sterile water is thereby supplied from the second liquid reservoir 202 for the filling system. On account of this change, process interruptions can be shortened or avoided and the efficiency of the system can be enhanced.

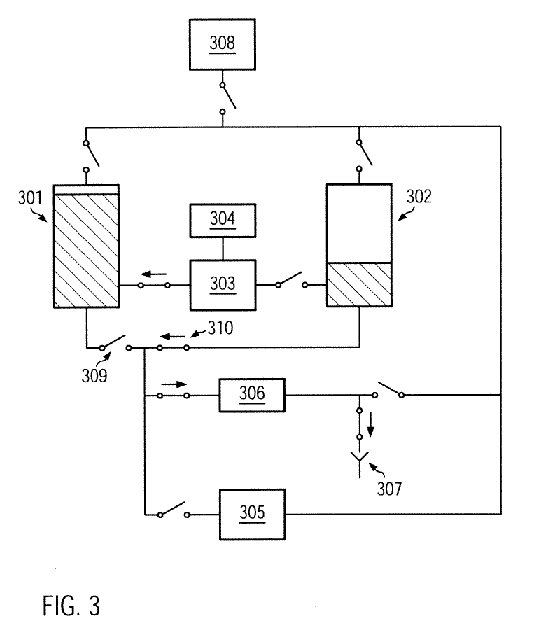

FIG. 3 illustrates the exemplary system of FIG. 2, wherein during withdrawal of sterile water from the second liquid reservoir 302 water has been filled into the first liquid reservoir 301 and is sterilized by means of disinfectant which is passed from the element 303 into the water in the first liquid reservoir 301. In other words, water is sterilized in the liquid reservoir 301 during withdrawal of sterile water from the liquid reservoir 302.

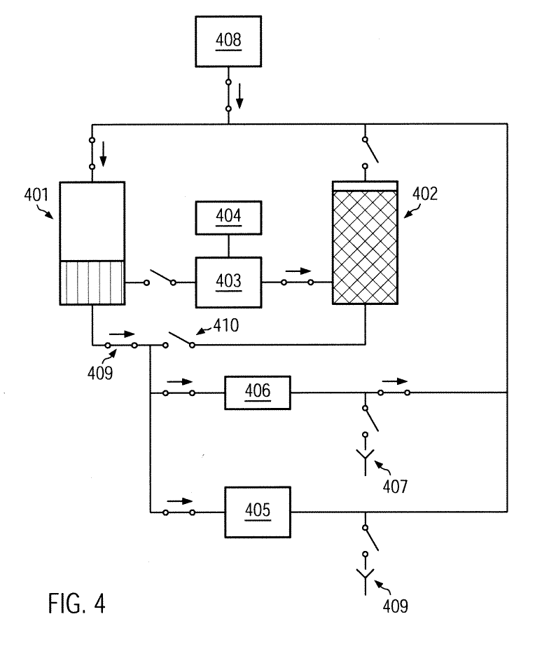

FIG. 4 illustrates a system that comprises an apparatus for providing a sterile liquid as well as a filling system. In this example a cleaning liquid is passed from a CIP system 408 via a first liquid reservoir 401 into the filling system, particularly into the filler 405 and the sterile-water consumption element 406. Valves of the filling system may here be configured such that the cleaning liquid is not discharged via outlets 407 and 409, respectively, but is circulated in the system.

During the cleaning operation, water is disinfected in a second liquid reservoir 402 by feeding disinfectant at a predetermined concentration by means of element 403. In this case the concentration can be chosen to be higher than in the examples shown in FIGS. 1-3. The higher concentration may e.g. serve to sterilize the system, particularly after a cleaning operation. Owing to the higher concentration of disinfectant the water in the second liquid reservoir 402 is sterilized at a faster rate. The higher concentration, however, is less material-compatible and there may be residues of the disinfectant evolving in the system. In the case of chlorine as the disinfectant, this higher concentration may be between 250 mg/l and 750 mg/l, particularly between 450 mg/l and 550 mg/l, particularly 500 mg/l of Cl⁻. In the case of peracetic acid as the disinfectant, the higher concentration may be 1,000 ppm to 10,000 ppm, particularly 1,500 ppm to 3,000 ppm, particularly 2,000 ppm.

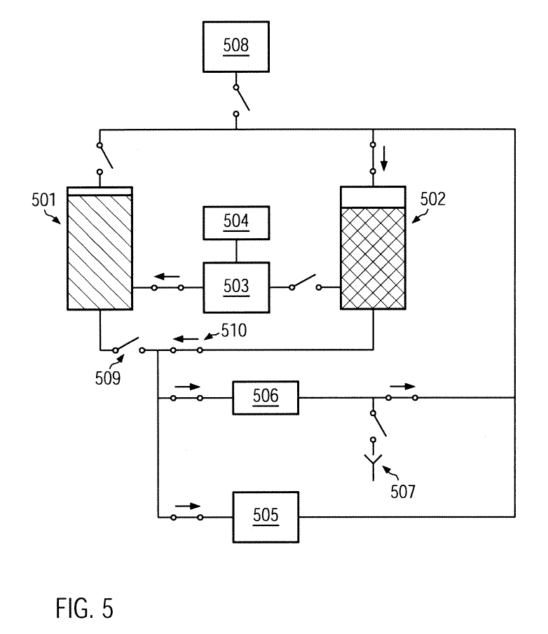

FIG. 5 illustrates an example of a system which comprises an apparatus for providing a sterile liquid as well as a filling system, wherein sterile water is used in a second liquid reservoir 502 for sterilizing the system, for instance after a cleaning operation as illustrated in FIG. 4. To be more specific, the sterile water may have the above-mentioned higher concentration of disinfectant. The valves of the filling system, in turn, may be set such that the sterile water is circulating in the system.

During sterilization by the sterile water, water is sterilized by a lower concentration of disinfectant in a first liquid reservoir 501. The disinfectant is passed by element 503 of the sterilizing device into the water in the liquid reservoir 501. This water can subsequently be used for after-rinsing the system because a sterilization of the system with a high concentration of disinfectant might cause residues of the disinfectant in the system.

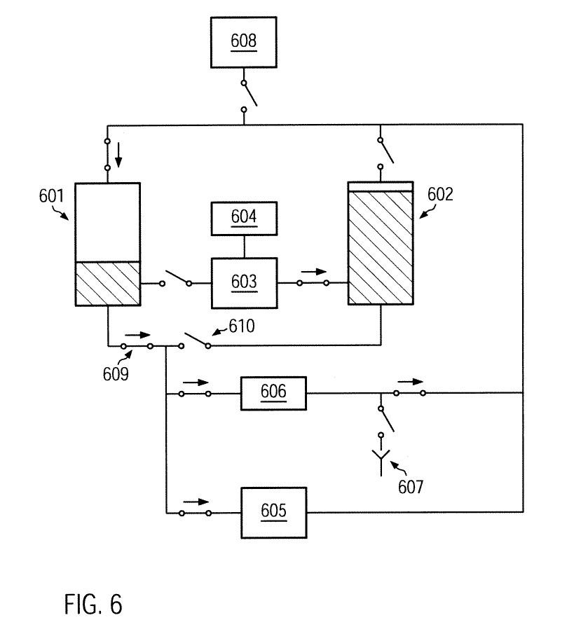

Such an after-rinsing operation is illustrated in the system in FIG. 6. The sterile water is here taken from the first liquid reservoir 601, which has a lower concentration of disinfectant, and is circulated through the system.

It goes without saying that features as indicated in the previously described embodiments are not limited to these special combinations and are also possible in any other desired combinations. Particularly, the apparatus for providing a sterile liquid can be combined with any desired further elements of a filling system.

1. An apparatus for providing a sterile liquid for a filling system for filling containers, comprising:
a first liquid reservoir for receiving a first liquid;
a second liquid reservoir for receiving a second liquid;
a sterilizing device for sterilizing the first and/or second liquid; and
a withdrawal device for selectively withdrawing a sterile liquid from the first or second liquid reservoir.

2. The apparatus according to claim 1, wherein the apparatus is configured such that during withdrawal of a sterile liquid from one of the liquid reservoirs, the liquid in the other liquid reservoir is sterilized.

3. The apparatus according to claim 1, wherein the sterilizing device introduces a disinfectant into the first and/or second liquid for sterilization.

4. The apparatus according to claim 3, wherein the sterilizing device is configured such that the disinfectant is introduced into the first and second liquid such that the first liquid has a first concentration and the second liquid has a second concentration of the disinfectant.

5. The apparatus according to claim 1, wherein the withdrawal device comprises a control element that is configured such that when the liquid level of the sterile liquid in the first and/or second liquid reservoir falls below a predetermined limit value, withdrawal of the sterile liquid from the first and/or second liquid reservoir is stopped automatically.

6. A system comprising a filling system for filling containers and an apparatus for providing a sterile liquid according to claim 1.

7. A method for providing a sterile liquid for a filling system for filling containers, comprising:
providing a first and a second liquid reservoir;
providing a first liquid in the first liquid reservoir and a second liquid in the second liquid reservoir;
sterilizing the first and/or second liquid; and
withdrawing a sterile liquid selectively from the first or second liquid reservoir.

8. The method according to claim 7, wherein during withdrawal of a sterile liquid from one of the liquid reservoirs, sterilizing the liquid in the other liquid reservoir.

9. The method according to claim 7, wherein the sterilizing operation comprises introducing a disinfectant into the first and/or second liquid.

10. The method according to claim 9, and introducing the disinfectant in a first concentration into the first liquid and in a second concentration into the second liquid.
